(19) United States
(12) Patent Application Publication
(10) Pub. No.: US 2007/0202242 A1
(43) Pub. Date: Aug. 30, 2007

(54) SYSTEM FOR MANUFACTURING EDIBLE GREETING CARDS

(76) Inventor: Kevin K. Cielo, Punxsutawney, PA (US)

Correspondence Address: BANNER & WITCOFF, LTD., 1100 13th STREET, N.W., SUITE 1200, WASHINGTON, DC, 20005-4051, US

(21) Appl. No.: 11/276,388

(22) Filed: Feb. 27, 2006

(51) Int. Cl. A23G 3/00

(52) U.S. Cl. 426/660

(57) ABSTRACT

In an embodiment, a user provides a customized greeting via an input device. The input device is in communication with a controller. In response to the customized greeting, the controller causes a confection to be shaped in accordance with the customized greeting. Once the confection is shaped, the confection is provided to the user. In an embodiment, the confection may be completely packaged before providing the confection to the user.

### BACKGROUND

Chocolate pieces have been a common present given in connection with birthdays and various holidays such as Valentine's Day. Significant effort has gone into developing unique shapes for chocolates in order to enhance their appeal. Existing chocolates are somewhat effective in relaying general caring thoughts of the giver of the chocolates but the gift is not considered personal in nature. Such chocolate givers commonly purchase greeting cards to give with the chocolates to make the gift seem more personal.

### BRIEF SUMMARY

In an aspect of the invention, systems and methods are provided to manufacture personalized edible greeting cards made from chocolate or other confectionary substance. Such aspects permit a user to input personalized information and/or to choose from predetermined messages. Such information and messages are etched into a chocolate bar or other edible card. The chocolate bar or other edible card thus provides a personalized message that may be given as a gift to a desired recipient.

In an illustrative embodiment, a kiosk is provided. The kiosk includes an input device on a housing that allows a user to select a desired shape of a confectionary substance. In an embodiment, the variation in the shape will correspond to a message shaped into the confectionary substance. The user selects the shape, which may be a customized message, and pays for the confection. The kiosk then shapes the confection with an etching tool. In an embodiment, the user may watch the etching of the confection through a work display. The kiosk then delivers the shaped confection to the user. In another embodiment, the kiosk may package the confection in a wrapping, such as transparent plastic, prior to delivering the confection to the user.

### BRIEF DESCRIPTION OF THE DRAWINGS

The present invention is illustrated by way of example and not limited in the accompanying figures in which like reference numerals indicate similar elements and in which:

FIG. 1 is an isometric of a confection etching system having a kiosk in accordance with an aspect of the present invention.

FIG. 2 is a schematic view of an illustrative etching assembly.

FIG. 3 is a schematic view of an alternative illustrative etching assembly.

FIG. 4a is a schematic view of an illustrative etching tool.

FIG. 4b is a schematic view of an alternative illustrative etching tool.

FIG. 4c is a schematic view of another alternative illustrative etching tool.

FIG. 4d is a schematic view of another alternative illustrative etching tool.

FIG. 5 is a schematic view of an illustrative embodiment of an etching tool associated with a confection holder transport.

FIG. 6 is a schematic diagram of an illustrative system in accordance with an aspect of the present invention.

FIG. 7 is a flow chart of an illustrative method of etching a confection in accordance with an aspect of the present invention.

FIG. 8 illustrates an illustrative distribution system for providing a confection to a user in accordance with an aspect of the present invention.

FIG. 9 illustrates another illustrative distribution system for providing a confection to a user in accordance with an aspect of the present invention.

### DETAILED DESCRIPTION

The description below provides various components that may be linked to other components, either directly or indirectly. This discussion is not intended to be limiting in that respect and, therefore, components may be connected or linked directly and/or indirectly without departing from the present invention unless otherwise noted.

As a summary, aspects of the invention are provided to manufacture personalized edible greeting cards, made from a confection such as chocolate or another edible composition. Thus, while other edible material compositions may be used, the majority of this section uses chocolate as the material for ease of description purposes. Features are provided to permit the user to create a message that is etched in the chocolate piece, such as a chocolate bar. A forming system is provided to form the created message in the chocolate bar. These elements may be contained on and in a kiosk that may also contain other features.

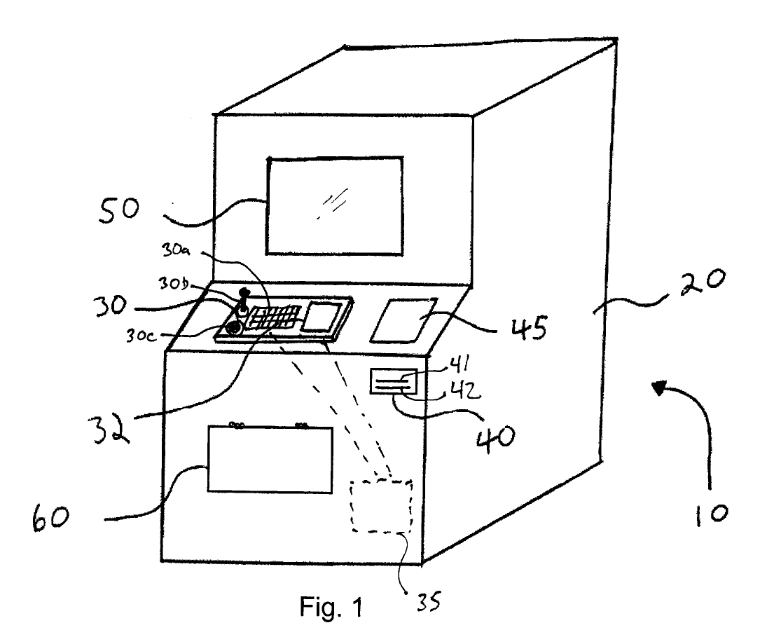

FIG. 1 shows an illustrative personalized edible greeting cards manufacturing system including an example kiosk 10. Kiosk 10 is shown to include a housing 20 that supports a user input device 30 that is accessible from the outside of the kiosk. The housing 20 may be made of one or more pieces and may include one or more access panels, not shown, on the side or rear of the kiosk 10. The access panels, if provided, allow an individual to service the components in and on kiosk 10, as well as to replenish pre-etched confection pieces or boxes, and/or for cleaning. It should be noted that housing 20 preferably will consist of a material that is resistant to abuse, such as a treated metal or a plastic/wood laminate arrangement.

The user input device 30 includes user input elements allowing a user to enter data, such as alphanumeric characters, and/or to make various choices associated with the production of a chocolate bar bearing a desired message. In an illustrative arrangement, the user input device 30 includes a keyboard and other key buttons 30a, a joystick 30b, and/or a trackball 30c. However, it is recognized that other input elements, such as a 5-way navigation button, may be provided on user input device 30.

In the illustrative arrangement, the system, and preferably the outside of the kiosk 10, also includes an interface display 32 to provide visual feedback for the customized greeting entry process. The interface display 32 and the user input elements 30a-30c on user input device 30, are coupled to a computer or other processing device 35 such that a user interface may be provided on interface display 32 and the user may navigate within the user interface, enter data, and make selections associate with the message to be provided on the personalized chocolate bar. Interface display 32 may be any of a number of different types of displays such as a CRT, LCD, or other device.

The interface display 32 provides visual feedback to allow the user to enter and/or edit the greeting before requesting the system to start etching the confection and/or to allow the user to navigate through various user interfaces associated with various options. In an alternative embodiment, the interface display 32 may be positioned separately from the input device 30. It should be noted that the term “greeting” refers to one or more symbols such as characters of an alphabet or characters. In an embodiment, the greeting may include two or more words and may include phrases or sentences. Generally, the greeting is only limited by the size of the confection being shaped and the size of the symbols being shaped. Thus, etching a confection may include removing portions of the confection so as to form a greeting on the confection.

To aid in the purchase of the confection, a currency reader 40 is provided to accept a payment on the outer surface of the kiosk 10. In an embodiment, the currency reader 40 may include a credit card reader configured to read a code on an authorization device such as a code on a magnetic strip of a credit card (not shown), and/or a receiver to accept a code provided in an RFID and/or a cash reader. A slot 41 for receiving a credit card may be provided. In such a configuration, the currency reader 40 would read in the code provided on the authorization device and would determine whether a valid account was associated with the code. If there was a valid account associated with the code, the system would charge the associated account after obtaining authorization. Additionally, the reader 40 may further include a cash reader capable of recognizing United States currency in the form of a bill or a token. A slot 42 for receiving cash currency may be provided. Any known suitable currency reader may be provided to accomplish this function. In an alternative arrangement, not shown, this currency confirmation feature may be eliminated or provided in a separate apparatus. To aid the user in the providing currency or currency authorization and/or for entering various greetings, written instructions 45 may be provided on the kiosk 10.

To add to the appeal of customizing the confection, the observation panel 50 may also be provided on the front of the kiosk 10. In an embodiment, the observation panel 50 may be a transparent window (such as a glass or plastic panel) that allows the user to watch the confection etching process. In lieu of an observation panel 50, an alternative arrangement may include an electronic display (which could either by display 32 or a separate display) coupled to a camera so as to provide a video image of the product being shaped.

Once the greeting is entered and the payment is confirmed, the confection is shaped by the etching system. Details of the etching system are disclosed hereinafter. Upon completion, the finalized confection is delivered to the user through the confection access door 60 on the outer surface of the kiosk 10. In an embodiment, the confection may automatically be placed in a packaging that may comprise a plastic material and may include a transparent side so that the greeting on the confection is visible. In an alternative embodiment, the finalized confection may be placed in a box and the box may include a cover, which may or may not have a transparent panel. In an alternative embodiment, the packaging and the confection may both be provided to the user and the user may then insert the confection into the packaging. As can be appreciated, however, it may be beneficial to package the confection in some wrapping so as to avoid the need for the user to touch the confection.

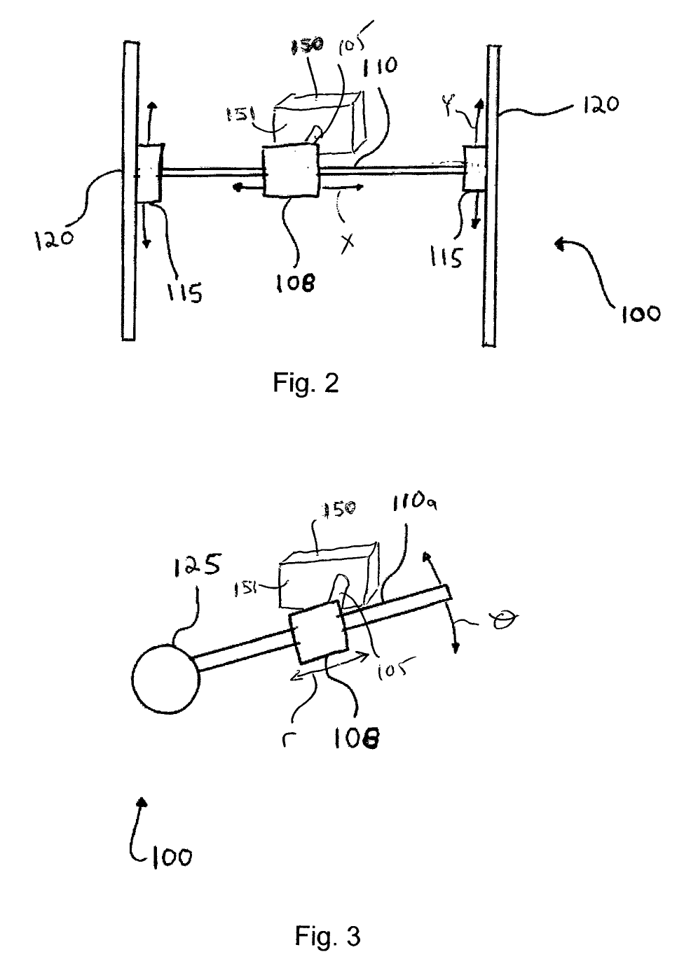

FIGS. 2-4 depict aspects of the etching assembly 100. The etching assembly 100 is used to etch the designated message into the confection product. The etching assembly 100 includes an etching tool 105, more of which will be discussed below. As depicted, the etching tool 105 is mounted to a base 108 which is movably mounted so as to be able to access at least all applicable areas on one surface 151 of the confection 150. In the arrangement of FIG. 2, the tool 105 and base 108 are mounted as part of a two-dimensional gantry system. Thus, base 108 is mounted on an arm 110 and can be moved relative to the arm 110 along a first axis. The arm 110 is supported by translating units 115 that are movable mounted to cross members 120 for movement relative along a second axis perpendicular to the first axis. Thus, as depicted, the etching tool 105 and its base 108 may move along a first axis along the arm 110 and can be translated in a perpendicular direction along the cross-members 120. Thus, a gantry type system enables the etching tool 105 to be configured to follow the shapes of characters, letters, etc, in a known manner. It should be noted that the etching assembly 100 will also include mechanisms for moving the etching tool 105, such as pneumatic or gear-based units, pulleys, servo-motors, etc, that are configured to control the translation of the etching tool 105. As these elements are known in the art, they are not shown for the simplicity purposes.

FIG. 3 illustrates an alternative embodiment of an etching assembly 100. In lieu of an X-Y gantry system, the etching tool 105 and its base 108 are supported and controlled by a radial (r) and angular (Θ) translational system using movement along a radial axis and by rotating the arm 110a forming the radial axis. Thus, in this arrangement, the base 108 is mounted on a radial arm 110a and can be moved relative to the arm 110a along this radial axis. The arm 110a is supported and controlled for rotational movement by a rotating support 125. Thus, etching tool 105 can be configured to follow the shapes of characters, letters, etc, in a known manner. As can be appreciated, numerous other configurations for supporting an etching tool 105 exist and need not be described herein.

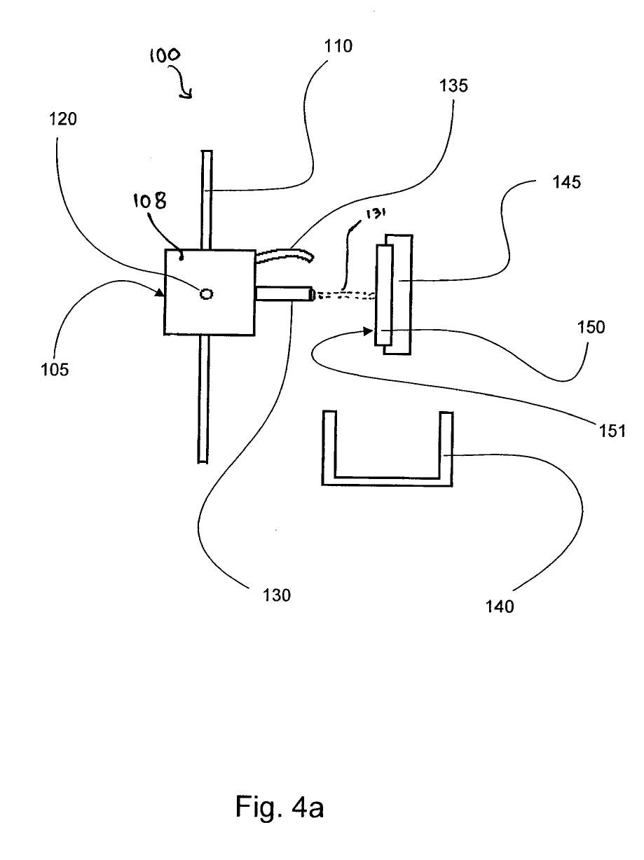

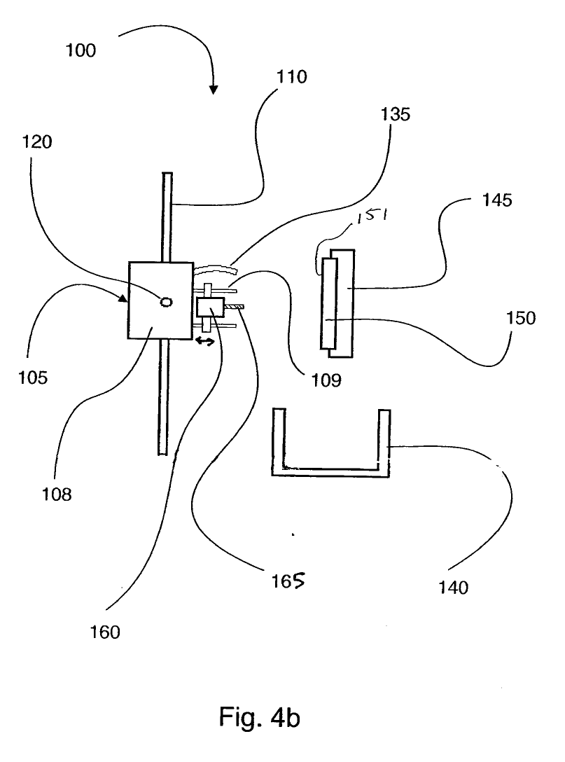

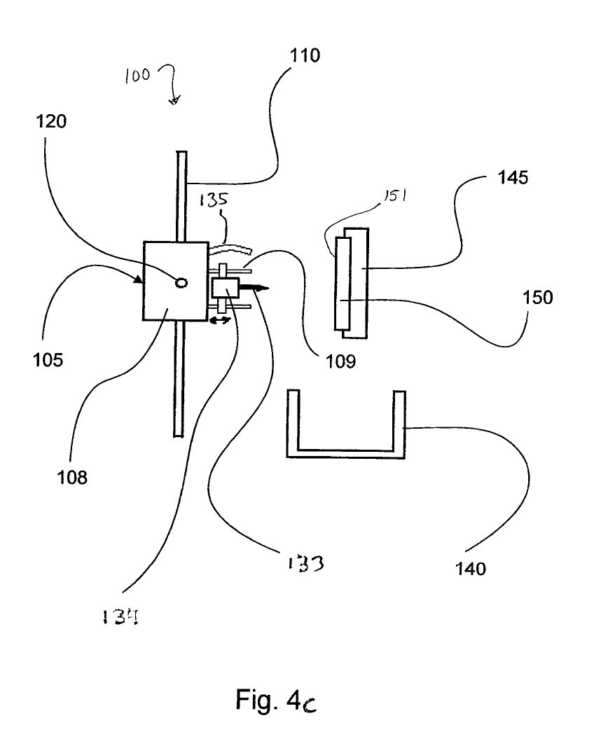

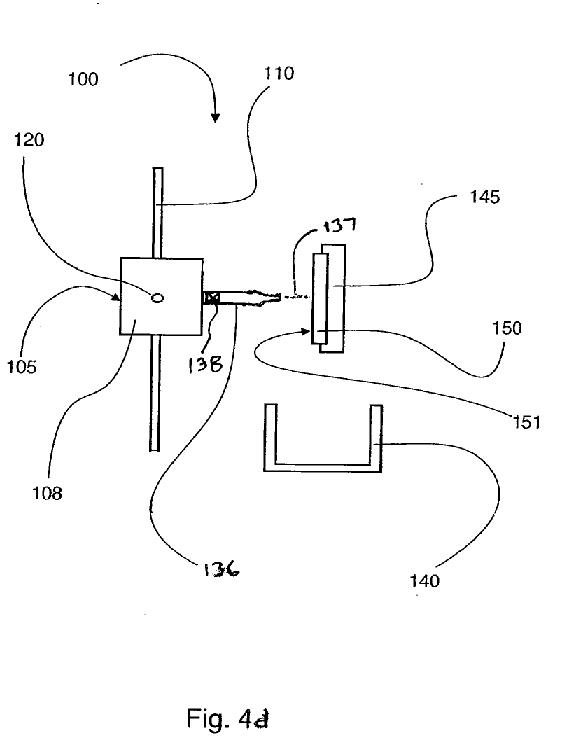

It should be understood by those skilled in the art that the embodiments of the etching tool 105 shown in FIGS. 4a-4d and described below are oriented with respect to the etching assembly configuration shown in FIG. 2. It would be understood by those skilled in the art that the same description may be applied with reference to the configuration shown in FIG. 3 and that the present invention is not so limited to the examples provided in FIGS. 4a-4d.

An embodiment of the etching tool 105 is depicted in FIG. 4a. In this arrangement, the etching tool includes a laser, schematically depicted by reference numeral 130. The laser 130 is mounted to the base 108 which may in turn be coupled to the arm 110 by a cross-member or suitable structural support 120 for movement as described above. As depicted, the etching tool 105 may be configured to translate along the arm 110, and the arm 110 would be movable along a perpendicular axis. In an alternative embodiment as previously described, the laser 130 and base 108 could be configured to selectively move in along a radial arm which is rotatable, such as shown in FIG. 3. The laser 130 is configured to direct a laser beam 131 onto a surface 151 of a confection 150 when the confection 150 is positioned in an etchable position on an etching surface 145. For the example shown in FIG. 4a, during the etching process, the etching surface 145 remains stationary. However, those skilled in the art would appreciate that the etching surface 145 may move the confection 150 prior to, during, and/or after the etching process.

The laser 130 is coupled to a power source (not shown) and is controlled by a controller (not shown) in accordance with the etching program. When the laser 130 is turned on, a concentrated beam 131 focused on the surface 151 of the confection 150, e.g., the bar containing chocolate. This will melt a small thickness of the confection at that location. Due to the laser 130 being moved relative to the confection 150 and being selectively turned on and off, the desired message previously input can be etched into the confection 150. The movement of the laser 130 relative to the confection 150 as well as the on/off functioning of the laser would be controlled in accordance with the etching program.

In addition to supporting laser 130, the base 108 may also support an optional nozzle 135. The nozzle 135 is coupled to an air supply (not shown) and may be controlled by the same controller as the laser 130 if desired. The nozzle 135 can provide a stream of air to help blow small melted confection particles, e.g., micro-chocolate beads, away from the remainder of the confection 150. The air stream provided by nozzle 135 may also help to cool the region of the confection immediately around the impingement point of the laser beam 131.

A retainer, schematically represented by numeral 140, is provided to collect particles of the confection 150 that are removed from the etching process. The retainer 140 may be lined with a removable and disposable lining. Accordingly, the liner and the removed confection particles may be discarded at periodic service times.

FIG. 4b depicts an alternative embodiment of the etching tool 105. In lieu of the laser 130, the base 108 supports a rotating cutting tool 165, such as a drill bit. The bit 165 may be any known configuration of bit, including angled bits and the like. When the rotating cutting tool 165 contacts the front surface 151 of the confection 150, the material of the confection 150, e.g., the chocolate, is melted in that area. If desired, a small amount of force may be applied to increase the depth of the etching. As shown, confection 150 is positioned in an etchable position on an etching surface 145. For the example shown in FIG. 4b, during the etching process, the etching surface 145 remains stationary. However, those skilled in the art would appreciate that the etching surface 145 may move the confection 150 prior to, during, and/or after the etching process.

The drill bit 165 may be carried on a block containing a motor 160. Additionally, the motor 160 may be coupled to one or more guides 109 enabling the motor 160 and bit 165 to translate along the guide 109. A device, not shown, such as a piston/cylinder, or motor/pulley assembly, is preferably coupled to the same controller, and may be used to move the motor 160 and bit 165 to translate along the guide 109 relative to base 108. Thus, in this arrangement, the etching tool may be configured to translate along three axes. This ability allows the cutting tool 165 to shape the confection 150 as desired. Due to the rotating cutting tool 165 being moved relative to the confection 150 in three orthogonal axes, the desired message previously input can be etched into the confection 150.

Some greetings may include one or more words, which in turn may include one or more characters. To form the characters on the confection 150, the cutting tool 165 may be placed in a positioned over the confection 150. The cutting tool 165 may then be translated along the guide 109 until the bit is inserted into the confection 150 at the desired depth. By controlling the translation of the etching tool 105 along the arm 110 and the cross-member 120, the character can be shaped in the confection. When the character is shaped, the cutting tool 165 may translate back along the guide 109 until the bit 165 clears the confection 150. The position of the etching tool 105 may be adjusted and then this process may be repeated. In such a manner, the greeting may be shaped on the confection 150.

Similar to the discussion regarding FIG. 4a, the nozzle 135 may be provided to aid in the removal of particles separated from the confection 150 by the bit 165. For example, the nozzle 135 may direct pressurized air unto the confection 150. Additionally, a retainer 140 may be provided as described above to collect particles of the confection 150 that are removed from the etching process.

FIG. 4c depicts another alternative embodiment of the etching tool 105. In lieu of a laser 130 or a rotating bit 165, the base 108 supports a heatable etching tool 133. This heatable etching tool 133 may be of any desired shape and configuration and may work similar to a soldering iron. When the heatable etching tool 133 contacts the front surface 151 of the confection 150, the material of the confection 150, e.g., the chocolate, is melted in that area. If desired, a small amount of force may be applied to increase the depth of the etching. As shown, confection 150 is positioned in an etchable position on an etching surface 145. For the example shown in FIG. 4c, during the etching process, the etching surface 145 remains stationary. However, those skilled in the art would appreciate that the etching surface 145 may move the confection 150 prior to, during, and/or after the etching process.

The heatable etching tool 133 is coupled to a power source (not shown) and is controlled by a controller (not shown) in accordance with the etching program. However, in contrast to the laser 130, the heatable etching tool 133 need not be powered on and off on a frequent basis and can be powered on and off at the beginning and end, respectively, of the forming of each etched confection 150. The heatable etching tool 133 can be coupled to an insulating supporting block 134. Additionally, the supporting block 134 may be coupled to one or more guides 109 enabling the supporting block 134 and the heatable etching tool 133 to translate along the guide 109. A device, not shown, such as a piston/cylinder, or motor/pulley assembly, is preferably coupled to the same controller, and may be used to move the supporting block 134 and the heatable etching tool 133 to translate along the guide 109 relative to base 108. Thus, in this arrangement, the etching tool 105 may be is configured to translate along three axes. This ability allows the heatable etching tool 133 to shape the confection 150 as desired. Due to the heatable etching tool 133 being moved relative to the confection 150 in three orthogonal axes, the desired message previously input can be etched into the confection 150.

FIG. 4d depicts an alternative embodiment of the etching tool 105. In lieu of a laser 130, a rotating bit 165, or a heatable etching tool 133, the etching tool 105 includes a nozzle 136 coupled to a pressurized fluid source (not shown). The nozzle 136 is preferably configured to emit a microspray 137 of the working fluid onto the front surface 151 of the confection 150. The spray 137 will etch the confection 150 by removing a small amount of the material of the confection 150 in the location of the spray 137. A valve 138 is coupled to a power source (not shown) and is controlled by a controller (not shown) in accordance with the etching program to etch the desired message into the confection 150. As shown, confection 150 is positioned in an etchable position on an etching surface 145. For the example shown in FIG. 4d, during the etching process, the etching surface 145 remains stationary. However, those skilled in the art would appreciate that the etching surface 145 may move the confection 150 prior to, during, and/or after the etching process.

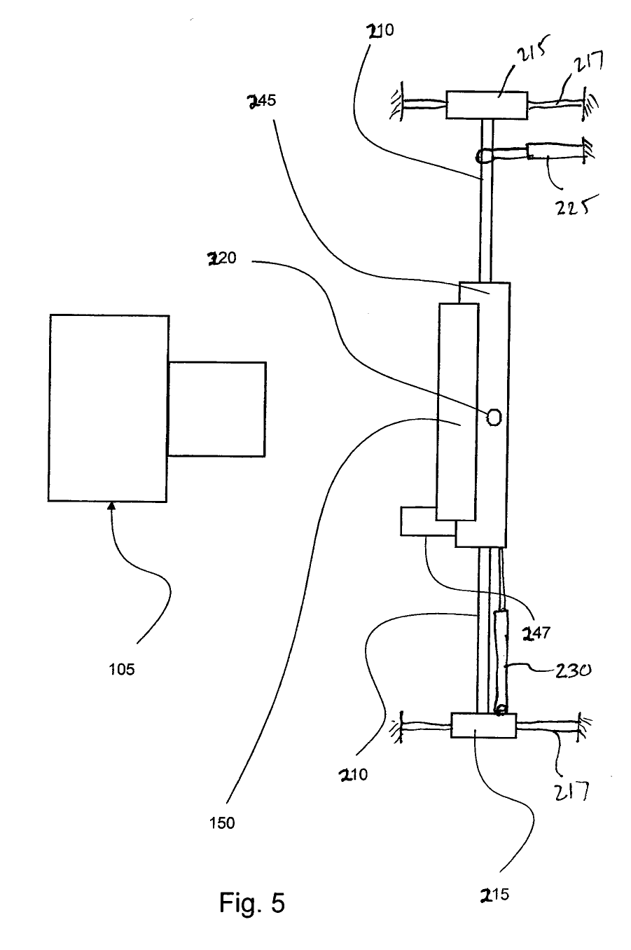

It is recognized that during this etching process, relative movement is imparted between the etching tool 105 and the confection 150. While FIGS. 4a-4d depict the etching tool moving and the confection 150 being held stationary during the etching process, the reverse and/or a combination is also possible. FIG. 5 depicts an arrangement of the etching assembly 100 that provides a confection transport 245 configured to change the position of the confection 150 during the etching process and the etching tool 105 is fixedly mounted or may otherwise be held stationary relative to the etching plane. In this arrangement, the etching tool 105 may be, for example, any of the etching tools 105 previously described. The confection transport 245 may be mounted to, and for movement along a perpendicular axis in the etching plane. In one arrangement, as shown, a portion of the transport holding the confection 150 may be vertically movable along a first arm 220. The confection transport 245 may also be mounted to and horizontally movable along arm 210. The arms 210 and 220 are oriented in transverse axes to provide movement of the confection 150 in the etching plane. A device such as a piston/cylinder assembly 230 or motor with pulleys (not shown) may be used to move the transport.

The confection transport 245 may also be configured to move towards and away from the etching tool 105. If the etching tool 105 is a laser (FIG. 4a) or a nozzle (FIG. 4d) then there would be no need for relative movement between the confection 150 and the etching tool 105. In such an arrangement, the previously described confection transport system could be mounted with guide elements 215 on an elongated guide 217. A device such as a piston/cylinder assembly 225 or motor with pulleys (not shown) may be used to provide movement of the transport 245 in three orthogonal axes. Alternatively, a combination of moving the confection transport 245 and the etching tool 105 may also be used.

To help reduce possible movement of the confection 150 in the confection transport 245 during the etching process, which may help to reduce variability, the confection transport 245 may include one or more clamps or latches schematically depicted by reference numeral 247. The latch 247 may be configured to hold a portion of the confection 150 in place. While numerous configurations are possible, in an illustrative embodiment the latch 247 may linearly displace and/or rotate into place so as to hold the control the position of the confection 150 relative to the confection transport 245.

If the system is not enclosed in a kiosk, an operator may be used to manually aid the processes of moving the pre-etched confection 150 to the confection transport 245, and removing the etched confection 150 from the confection transport 245 to the customer. However, such steps would be automated if done in a kiosk. The user may also be given a choice of confection type, e.g., dark, milk, or white chocolate. In addition, packaging of the confection after it is shaped, e.g., placing it into a box may also be offered to a user. These steps may be performed regardless of whether the system is automated.

For example, turning to FIG. 8, a confection blank 150 may initially be stored in one or more stacks 150. Multiple stacks 150a and 150b of different confection types, i.e., dark chocolate, milk chocolate, white chocolate, may be used. Any desirable article moving device, schematically represented by reference numeral 161, such as a robotic arm and/or a conveyor, may be used to transport a confection blank 150 from a stack 150a or 150b to the etching station, such as shown in FIGS. 4a-4d or FIG. 5. Once the confection blank 150 is etched with the message, another article moving device, schematically represented by reference numeral 162, such as a robotic arm and/or a conveyor, may be used to transport the etched confection 150 from the etching station to a packaging station if one is implemented. Specifically, the article moving device 162 may deposit the etched confection into an open box 164. The bottom of the box may be reversely nested into the top of the box so that the user received the confection in an exposed manner in the bottom of the box and can remove the box top and close the box with the confection therein. The nested boxes may be stored in a stack 164a at the packaging station, and any desirable device may be used to withdraw the boxes from the stack. Any desirable article moving device, such as a robotic arm and/or the schematically depicted conveyor 166 may be used to transport the packaged confection to the appropriate location in the kiosk so that the user may take the etched confection. In another arrangement, the etched confection 150 could be placed in the bottom of the box and the box top may be transported separately. It is noted that the article moving devices 161, 162, and 166 need not be separate devices and that these transport functions may be combined in less that that number of devices. For example, a more complex single robotic device could be used to transport the confection at all the stages.

Thus, in one arrangement, once the etching was complete, the shaped confection 150 in the open face box 164 could be placed on a conveyer 166. The conveyer 166 could then transport the confection 150 in the open face box 164 to a receiving tray 169. The receiving tray 169 may be supported by the housing 20 of kiosk 10 and the access door 60 may be configured to enable the insertion of an individual's hand into the access provided in the housing 20. The user could take the shaped confection 150 positioned in the open face box 164 along with the lid which may be nested with, or separate form, the other half of the box. The user could then place the lid on the open face box 164 and the shaped confection 150 would be packaged. In another arrangement, the box may be made form a single blank such that there is only one box part and the user could close the box moving one or more pivotable flaps.

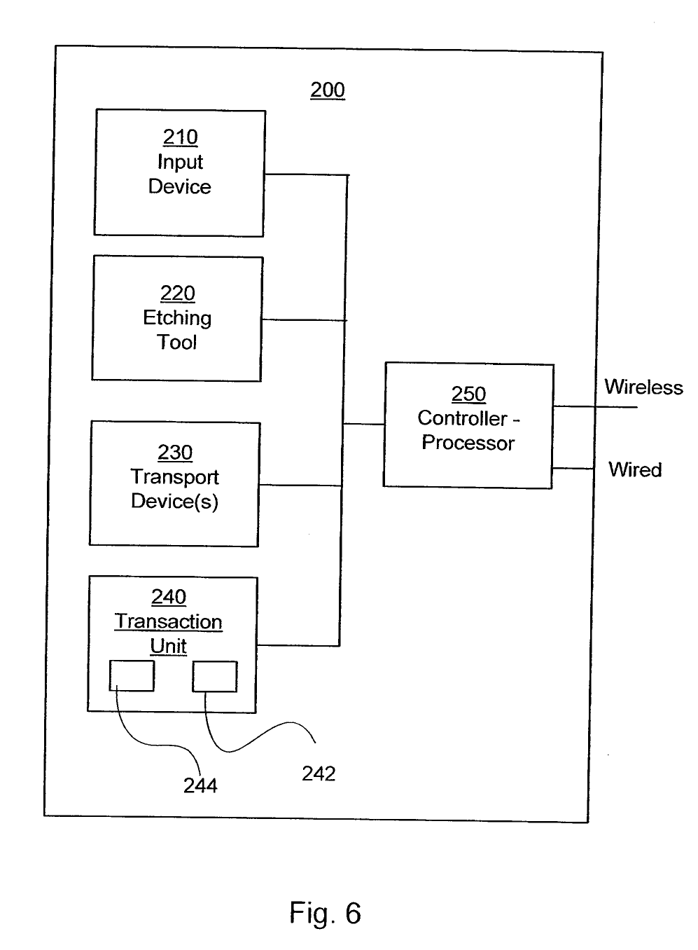

Turning to FIG. 6, a schematic representation of a system 200 for etching a confectionary substance is illustrated. The system 200 includes an input device 210, an etching tool 220, the confection transport device(s) 230, a transaction unit 240 and controller 250. The controller 250 may be a computer or other electrical processing device and preferably provides instructions to control the processes. The controller 250 accepts input from the user through the input device 210, processes the transaction through the transaction unit 240, instructs the etching tool 220 to shape the confection according to the user input, and instructs the various confection transport devices 230 to move the confection throughout the process.

The transaction unit 240 includes a reader 242 and may include a communication unit 244. As discussed above, the reader 242 may read a code encoded on the authorization device provided by the user, where the code is linked to a user account. In an alternative, the reader 242 may be configured to recognize a currency or a token. In the event that the reader is configured to read a code, it may be beneficial to include a communication unit 244. The communication unit 244 may enable relatively prompt authorization to charge the account linked to the code encoded in the authorization device. In an embodiment the communication unit 244 may communicate in a wireless manner.

The controller 250 may also include an external ordering module enabling a user to order an etched confection from a location external from the kiosk. Such can receive for example signals either wired or wirelessly, such as from the Internet or a mobile telephone. The order may include the desired data needed to create and process the etched confection and thus preferably message data and payment data, and may also include other data such as choice of confection type data.

The input device 210 may be a keyboard, a joystick, a touch pad, a trackball a five-way navigation switch or any other known device configured to accept user input. In operation, the user provides input as to the desired greeting. This information is provided to the controller 250 and the controller 250 processes the information and instructs the etching tool 220 and the confection transport 230, accordingly.

To simplify this process, a set of pre-generated greetings may be provided to the user. In addition, a set of templates may be provided that allow the user to enter in a name rather then the entire greeting. However, providing the ability to allow the user to completely customize the greeting may be beneficial because templates and pre-generated greetings are inherently limited in their ability to express a particular feeling or thought.

While not required, the use of wireless communication allows the system to avoid the need for a communication line and instead only require a power source. Furthermore, if the kiosk was configured to only accept, for example, credit card payments, the kiosk would not collect any physical money and would be less of an attractive target for potential thieves. In addition, the kiosk could even include a power source so as to be completely self-sufficient. Naturally, the kiosk would eventually need to be restocked with confections.

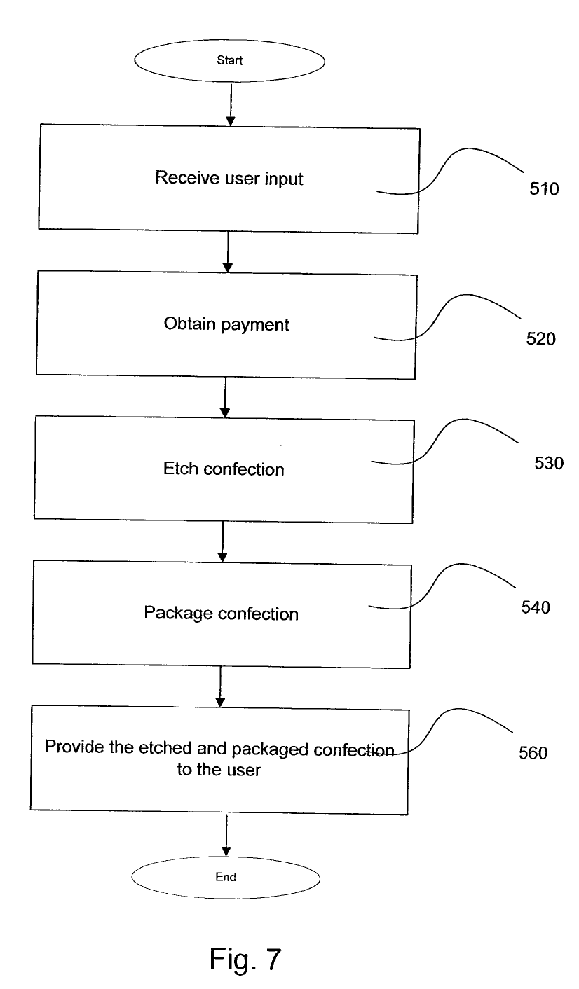

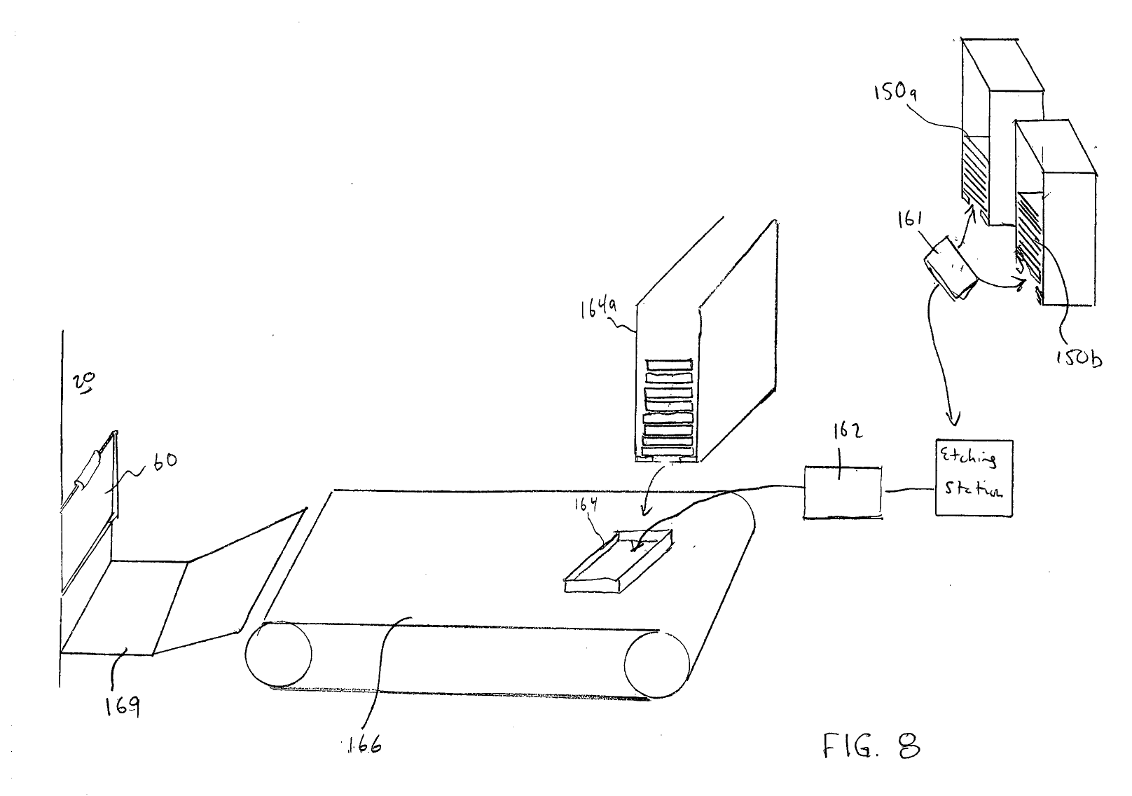

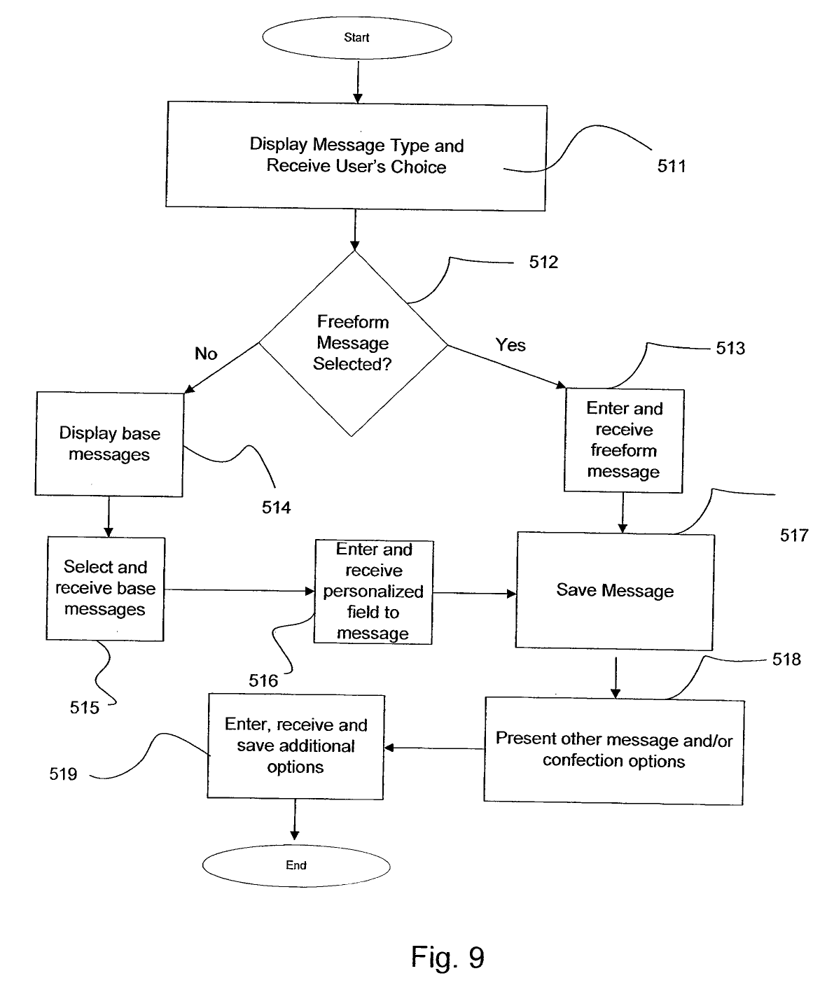

Turning now to FIGS. 7 and 9, a method of etching a confection is provided. In step 510, user input is received from a potential purchaser of a shaped confection. The user input may be provided as discussed above or may be provided from a remote location through a communication network such as the Internet. FIG. 9 shows in more detail steps associated with step 510. For example, the receive user input step 510 may include steps to enable the user to input the message. In one arrangement, at step 511, a query may be provided and the selection received as to whether he/she wishes to create a freeform message or customize an existing message. If at step 512, the user's choice is a freeform message, the user is prompted at step 513 to enter the message in a manner similar to how text is entered into a word processor program. The message is stored in the computer at step 517.

If at step 512, the user's choice is to customize an existing message, a subroutine and submenus are provided to the user at step 514 so that the user may select for existing messages stored in the computer. Menu choices may be provided to aid the user in this selection process and may be group by holiday (e.g., Valentine's Day, Easter, etc.), occasion (e.g., birthday, graduation, anniversary, etc), and/or any other desirable grouping. At step 515, the user selects a desired base message to be customized and the choice is received. At step 516, the user may enter/edit customizable fields in the base massage. For example, a base message may be as follows:

Dear ***1***:
Roses are red,
Violets are blue,
Sugar is sweet,
And so are you.
   Happy Valentines Day!
   Love ***2***

In such a message, the name of the intended recipient and the name of the sender would be entered by the user for fields 1 and 2, respectively to complete the message. Such would be similar to how a user would enter text into a word processor program. The message is stored in the computer at step 517.

After the message is stored, the user may be prompted to make other selections and the responses are stored at step 518. The choices could be message based (e.g., type of font for the message to be etched) or confection type based (e.g. dark chocolate or milk chocolate). During step 519, the user may enter the desired data via the input devices 30 and view the user interface and see feedback of the entered data on display 45 before the additional options are saved.

In step 520, payment is provided. While payment may be provided as discussed above, in an embodiment the payment information may be provided concurrently with the user input. The payment may be provided via currency reader 40 and may be done via cash, credit card, or any other desired form of currency.

Next in step 530 the confection is shaped based form the stored message and other stored selections. As discussed above, the confection may be shaped with a variety of etching tools. In connection with step 530, the user may watch the etching of the confection through window 50. If the etching is done remotely from the user, such as over the Internet, a video of the etching process may be provided to the user.

Next, in step 540, the confection is packaged. As discussed above, depending on the configuration of the etching tool and the confection transport, different methods may be used to package the confection. It should also be noted that the external packaging may also be customized. For example, it is known to provide a graphic on packaging and in an embodiment a graphic could simulate a wrapped present.

In step 560 the confection is directed to a user that may be different from the user that ordered the confection. This may include conveying the confection partially or completely packaged. If the confection is ordered over the Internet, for example, the confection will generally need to be delivered to a shipping agent who will then deliver the confection to the user. For the purpose of the present invention, step 560 is satisfied upon delivery of the confection to the shipping agent.

The present invention has been described in terms of preferred and illustrative embodiments thereof. Numerous other embodiments, modifications and variations within the scope and spirit of the appended claims will occur to persons of ordinary skill in the art from a review of this disclosure.

What is claimed is:

1. A system for making a personalized edible confectionary greeting card from a confectionary blank, comprising:
a user input device configured to input at least a portion of a message; and
an etching tool configured, in operation, to etch readable characters of the message into the confectionary blank.

2. The system of claim 1, further comprising a confectionary blank transport configured, in operation, to move the confectionary blank to a position adjacent the etching tool.

3. The system of claim 1, wherein the etching tool includes a laser configured to burn the message into the confectionary blank.

4. The system of claim 1, wherein the etching tool includes a nozzle coupled to a fluid source configured to emit a stream of fluid onto the confectionary blank to form the message.

5. The system of claim 1, wherein the etching tool includes a heatable etching tool configured to contact the confectionary blank and burn the message therein.

6. The system of claim 1, wherein the etching tool includes a rotatable bit to scribe the message into the confectionary blank.

7. The system of claim 1, further comprising an X-Y gantry system, the etching tool being coupled to the X-Y gantry system.

8. The system of claim 1, further comprising a radial-angular (r-Θ) translational movement system, the etching tool being coupled to the radial-angular (r-Θ) translational movement system.

9. The system of claim 1, further comprising:
a housing having an interior region and an exterior,
wherein the etching tool is located entirely within the interior region and the user input device is positioned for use and access from the exterior.

10. The system of claim 9, further comprising:
a gantry system located entirely within the interior region, the etching tool being coupled to the X-Y gantry system; and
an observation panel forming a part of the housing and configured to allow, in operation, a user to watch the etching of the confectionary blank from the exterior of the housing.

11. The system of claim 10, further comprising a currency reader accessible from the exterior of the housing to enable users to make a payment.

12. The system of claim 10, further comprising:
a stack of confectionary blanks located in the interior region,
wherein the confectionary blanks are chocolate bars,
wherein the user input device includes at least one of a keyboard, a joystick, and a trackball.

13. A kiosk for making an edible confection with a customized message comprising:
a housing having an interior and an exterior;
means accessible from the housing exterior for forming a message; and
means for etching the message into an edible confection located in the interior of the housing.

14. The kiosk of claim 13, further comprising:
payment accepting means accessible from the housing exterior for receiving a payment from a user; and
an electronic display enabling the message to be displayed prior to being etched into the edible confection.

15. The kiosk of claim 14, further comprising:
a stack of chocolate edible confections in the interior,
wherein the means accessible from the housing exterior for forming the message includes a keyboard.

16. The kiosk of claim 15, further comprising:
an observation panel configured to allow, during operation, the user to view the etching of the edible confection; and
an access door enabling the user to reach into the interior of the housing to pickup the edible confection etched with the message, wherein the message is a customized message.

17. A method of etching a confection, comprising:
accepting input data from a user related to a customized message;
mechanically etching a confection with the customized message; and
providing the etched confection to the user.

18. The method of claim 17, wherein the step of accepting input data includes accepting the input data over an Internet connection.

19. The method of claim 17, further comprising placing the etched confection in a box prior to the providing step.

20. The method of claim 17, wherein the step of accepting input data includes accepting a pre-formed message selection from the user and accepting freeform data from the user.
